(19) United States
(12) Patent Application Publication
(10) Pub. No.: US 2017/0054680 A1
(43) Pub. Date: Feb. 23, 2017

(54) CONTROL METHOD, INFORMATION PROCESSING APPARATUS, AND STORAGE MEDIUM

(71) Applicant: FUJITSU LIMITED, Kawasaki-shi (JP)

(72) Inventor: MASAO ITO, Kawasaki (JP)

(73) Assignee: FUJITSU LIMITED, Kawasaki-shi (JP)

(21) Appl. No.: 15/194,628

(22) Filed: Jun. 28, 2016

(30) Foreign Application Priority Data
Aug. 19, 2015 (JP) 2015-162219

(51) Int. Cl. H04L 29/12; H04L 12/741; H04L 12/935

(52) U.S. Cl. CPC H04L 61/2046; H04L 49/30; H04L 45/74; H04L 61/2007; H04L 61/6022

(57) ABSTRACT

A control method executed by an information processing apparatus that includes a plurality of communication ports, the control method includes storing a port list including information of the plurality of communication ports and addresses respectively allocated to one of the plurality of communication ports; detecting that an address, which belongs to a communication segment of a first communication port among the plurality of communication ports, is not set to a device coupled to the first communication port, the communication segment indicating a group of addresses that are capable of mutual communication; specifying a second communication port to which an address that belongs to a second communication segment of the device, is set; updating the port list by exchanging an address allocated to the specified second communication port, and an address allocated to the first communication port; and executing communication with the device based on the updated port list.

### CROSS-REFERENCE TO RELATED APPLICATION

This application is based upon and claims the benefit of priority of the prior Japanese Patent Application No. 2015-162219, filed on Aug. 19, 2015, the entire contents of which are incorporated herein by reference.

### FIELD

The embodiment discussed herein is related to a control method, an information processing apparatus, and a storage medium.

### BACKGROUND

There are cases in which power is cut, and all connected communication cables are removed when performing part replacement in an information processing apparatus. In such a case, a worker returns wiring of the connected communication cables to an original state in order to operate the information processing apparatus again.

In the field of servers, there are many cases in which a connection destination of a communication port is determined in advance for security purposes, or the like. Therefore, a worker performs wiring by confirming a setting of a communication port and a physical position of the communication port in order to return the wiring of the communication cables to the original state. However, in wiring work, whether or not appropriate connection between the communication cables and the communication port is implemented and the information processing apparatus is returned to a state in which communication is possible is dependent on the accuracy, skill, and the like of the wiring work of the worker. Therefore, there are cases in which mistakes occur due to human error.

Countermeasures for identifying the communication cables, and the like, are performed by tagging the communication cables in order to avoid human errors in wiring communication cables. However, there are circumstances in which the settings of a network are changed due to a usage status or the like, and there are circumstances in which inconsistencies of the tags and the communication cables occur. Therefore, a resolution method for communication cable wiring errors other than a method in which a person makes an assessment is desired.

In network relay apparatuses, a technique that autonomously associates logical information and physical information with one another is known. Network relay apparatuses do not set an association between physical information of a port number and logical information such as an Internet Protocol (IP) address or a Virtual Local Area Network (VLAN)-ID in configuration information. In place of this, network relay apparatuses set an identifier that is associated with logical information. Further, after the connection of cables, L2 packets that include an identifier and a port number are mutually sent between network relay apparatuses. As a result of the network relay apparatuses mutually receiving the L2 packets, an identifier of a partner apparatus that is connected to each port of a host apparatus is identified, and an association between logical information and physical information is determined (for example, refer to Japanese Laid-open Patent Publication No. 2012-39542).

### SUMMARY

According to an aspect of the invention, a control method executed by a processor included in an information processing apparatus that includes a plurality of communication ports, the control method includes storing a port list including information of the plurality of communication ports and addresses respectively allocated to one of the plurality of communication ports; detecting that an address, which belongs to a communication segment of a first communication port among the plurality of communication ports, is not set to a device coupled to the first communication port, the communication segment indicating a group of addresses that are capable of mutual communication; specifying a second communication port to which an address that belongs to a second communication segment of the device, is set; updating the port list by exchanging an address allocated to the specified second communication port, and an address allocated to the first communication port; and executing communication with the device based on the updated port list.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view that describes an example of an information processing apparatus according to the present embodiment and various devices;

FIG. 2 is a view that describes an example of a hardware configuration of the information processing apparatus according to the present embodiment;

FIG. 3 is a view that describes an example of the information processing apparatus in a correct wiring state;

FIG. 4 is a view that describes an example of a process of connection confirmation in a communication section;

FIG. 5 is a view that describes an example of an incorrectly wired information processing apparatus;

FIG. 6A is a view (1 of 2) that describes an example of a process that updates a port list;

FIG. 6B is a view (1 of 2) that describes an example of a process that updates the port list;

FIG. 7 is a view that describes an example of a transmission packet frame;

FIG. 8A is a flowchart that describes an example of a process in the information processing apparatus according to the present embodiment;

FIG. 88 is a flowchart that describes an example of a process in the information processing apparatus according to the present embodiment;

FIG. 9 is a view that describes an example of an information processing apparatus in which there are wiring errors across a plurality of communication ports; and

FIG. 10 is a view (2 of 2) that describes an example of a process that updates the port list.

### DESCRIPTION OF EMBODIMENT

In the field of servers, there are many cases in which a connection destination of a communication port is determined in advance for security purposes, or the like. In a case in which an erroneous wiring is made in such a settings environment, a worker restarts wiring of the communication cables again. Therefore, there is a problem in that the burden of the work increases in tandem with an increase in the number of communication ports. Even in statuses in which there are wiring errors, it is desirable that it be possible to autonomously transition to a state in which communication is possible.

In such an instance, the information processing apparatus according to the present embodiment provides a function that automatically corrects communication port settings to an IP address that matches an application of connected network without being dependent on the wiring state of a communication cable.

Hereinafter, an embodiment will be described with reference to the drawings.

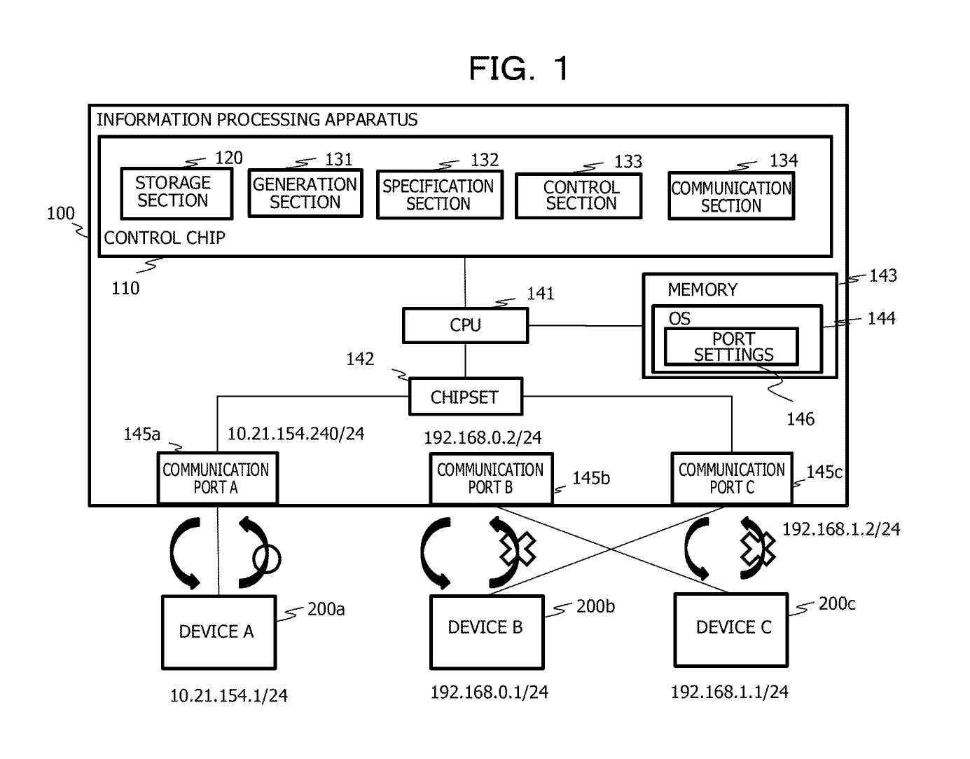

FIG. 1 is a view that describes an example of a process of an information processing apparatus according to the present embodiment. An information processing apparatus 100 according to the present embodiment includes a control chip 110, a Central Processing Unit (CPU) 141, a chipset 142, a memory 143, a communication port 145a, a communication port 145b and a communication port 145c. The CPU 141 is a processing circuit that executes programs that are executed in the information processing apparatus 100. The chipset 142 is used in the control of various types of hardware that is installed in the information processing apparatus 100. Control of the chipset 142 is executed as a result of processing orders from the CPU 141. The chipset 142 is provided with programs of an Operating System (OS) 144.

The memory 143 stores information of port settings 146. The port settings 146 stores physical Media Access Control (MAC) addresses of the communication port 145a, the communication port 145b and the communication port 145c, and IP addresses that are associated with each physical MAC address. For example, “10.21.154.240/24” is set as the IP address that corresponds to the communication port 145a. The notation 724″ in the IP address represents “255.255.255.0” of the subnet mask in Classless Intersect-Domain Routing (CIDR). “192.168.0.2/24” is set as the IP address that corresponds to the communication port 145b. For example, “192.168.1.2/24” is set as the IP address that corresponds to the communication port 145c.

From a viewpoint of security, in a case in which a connection destination of a communication port is determined in advance for security purposes, or the like, for example, the communication ports 145 and a connection destination device 200 are set so as to belong to the same communication segment. More specifically, “10.21.154.1/24” is set as the IP address in a device 200a. Therefore, the device 200a and the communication port 145a belong to the communication segment of “10.21.154.1 to 255”. “192.168.0.1/24” is set as the IP address in a device 200b. Therefore, the device 200b and the communication port 145b belong to the communication segment of “192.168.0.1 to 255”. “192.168.1.1/24” is set as the IP address in a device 200c. Therefore, the device 200c and the communication port 145c belong to the communication segment of “192.168.1.1 to 255”. It is possible for the communication ports 145 and the devices 200 to communicate with one another in cases in which the communication ports 145 and the devices 200 belong to the same communication segment. Meanwhile, communication is not possible between communication ports 145 and the devices 200 that belong to different communication segments.

The example of the information processing apparatus 100 that is illustrated in FIG. 1 is an example of a case in which a worker has connected communication cables, which are coupled to the device 200b and the device 200c, to incorrect communication ports. More specifically, a communication cable that is to be coupled to the device 200c is coupled to the communication port 145b. A communication cable that is to be coupled to the device 200b is coupled to the communication port 145c. When this occurs, the information processing apparatus 100 does not communicate with the device 200c since the communication segments of the communication port 145b and the device 200c are different. In the same manner, the information processing apparatus 100 does not communicate with the device 200b since the communication segments of the communication port 145c and the device 200b are different.

The information processing apparatus 100 according to the present embodiment provides a function that automatically corrects communication port settings to an IP address that matches an application of a connected network without being dependent on the wiring state of a communication cable. Therefore, in the information processing apparatus 100 according to the present embodiment, even in a wiring state of incorrect communication cables, it is possible to perform communication that matches an application by automatically correcting the communication port settings to an IP address that matches an application of a connected network. In order to provide this function, the information processing apparatus 100 is provided with the control chip 110.

Hereinafter, an example of a process of functions that automatically corrects the communication port settings that are used in the example of the information processing apparatus 100 according to the working example of FIG. 1 will be described.

(A1) A communication section 134 selects a single communication port. Further, the communication section 134 sends an order to perform connection confirmation (for example, a Ping) of a communication segment network of an IP address that corresponds to the selected communication port, to the CPU 141. The process of (A1) may be executed when the power of the information processing apparatus 100 is input.

(A1.1) The communication section 134 sends an order to perform connection confirmation (for example, a Ping) of a communication segment network to which the selected communication port 145a belongs, to the CPU 141. The CPU 141 sends the connection confirmation from the communication port 145a to the communication segment network. The device 200a, which belongs to the same communication segment as the communication port 145a, returns a response to the connection confirmation to the information processing apparatus 100. A control section 133 determines that there is not a problem in the connection of the communication port 145a and the device 200a.

(A1.2) The communication section 134 sends an order to perform connection confirmation (for example, a Ping) of a communication segment network to which the selected communication port 145b belongs, to the CPU 141. The CPU 141 sends the connection confirmation from the communication port 145b to the communication segment network. However, the device 200c, which belongs to a different communication segment, is coupled to the communication port 145b. Therefore, the response to the connection confirmation is returned as a “response error”. The control section 133 determines and detects that there is a problem in the device 200 that is coupled to the communication port 145b.

(A1.3) The communication section 134 sends an order to perform connection confirmation (for example, a Ping) of a communication segment network to which the selected communication port 145c belongs, to the CPU 141. The CPU 141 sends the connection confirmation from the communication port 145c to the communication segment network. However, the device 200b, which belongs to a different communication segment, is coupled to the communication port 145c. Therefore, the response to the connection confirmation is returned as a “response error”. The control section 133 determines that there is a problem in the device 200 that is coupled to the communication port 145c.

(A2) A specification section 132 initiates a process that specifies a correct connection destination.

(A2.1) The specification section 132 initiates a specification process of a device that is coupled to the communication port 145b, for which there was a response error. The specification section 132 acquires communication segments of communication ports (the communication port 145a and the communication port 145c) that differ from the communication port 145b, for which there was a response error. The communication section 134 sends orders to perform connection confirmation (for example, a Ping) of the communication segment networks of the communication ports (the communication port 145a and the communication port 145c), to the CPU 141. The connection confirmation is sent from the communication port 145b, for which there was a response error. When this occurs, a response to the connection request from the communication port 145b is fed back from the device 200c. The specification section 132 specifies that the device that belongs to the communication segment of the communication port 145c is wired to the communication port 145b.

(A2.2) The specification section 132 initiates a specification process of a device that is coupled to the communication port 145c, for which there was a response error. The specification section 132 acquires communication segments of communication ports (the communication port 145a and the communication port 145b) that differ from the communication port 145c, for which there was a response error. The communication section 134 sends orders to perform connection confirmation (for example, a Ping) of the communication segment networks of the communication ports (the communication port 145a and the communication port 145b), to the CPU 141. The connection confirmation is sent from the communication port 145c, for which there was a response error. When this occurs, a response to the connection request from the communication port 145c is fed back from the device 200b. The specification section 132 specifies that the device that belongs to the communication segment of the communication port 145b is wired to the communication port 145c.

(A3) As a result of the processes of (A1) to (A2.2), it is understood that the communication cables that are coupled to the communication port 145b and the communication port 145c are coupled in reverse. In such an instance, a generation section 131 updates a port list (to be described later) that maintains IP addresses that are associated with communication ports separately from the port settings 146 that are stored in the OS 144. In the example of the information processing apparatus 100 of FIG. 1, the generation section 131 generates a port list in which the IP address of the communication port 145b and the IP address of the communication port 145c are exchanged.

(A4) From then on, in a case of performing communication with devices in the communication segments that belong to the communication port 145b and the communication port 145c, the control section 133 controls the CPU 141 so as to perform communication based on the IP addresses that are included in the port list.

In this manner, the control chip 110 can sense connection errors of the communication cables that are coupled to the information processing apparatus 100. When a connection error is detected, the control chip 110 generates a port list in which the correspondence relationships of the communication ports and the IP addresses are corrected. The control chip 110 can make normal communication possible in a status in which there is a wiring error by controlling communication with the devices based on the port list.

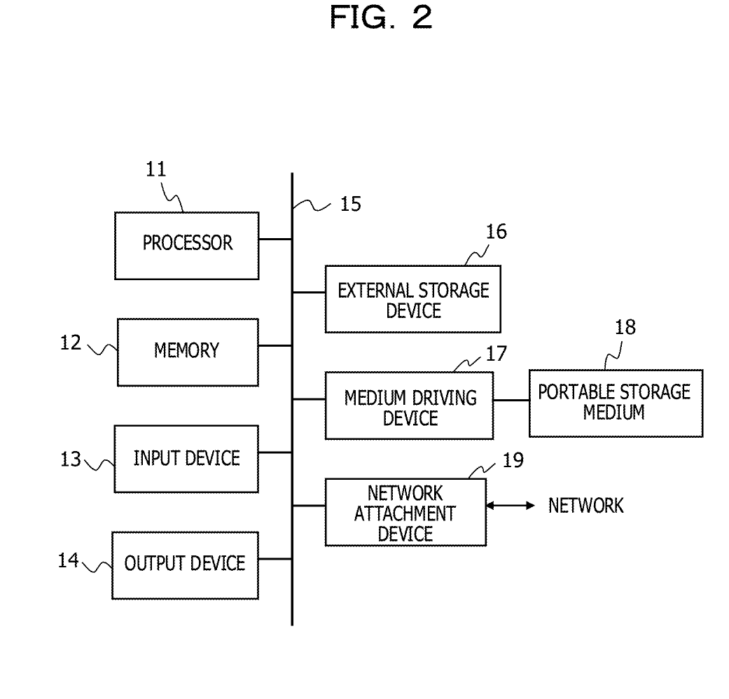

FIG. 2 is a view that describes an example of a hardware configuration of the information processing apparatus according to the present embodiment. The information processing apparatus 100 is provided with a processor 11, a memory 12, a bus 15, an external storage device 16 and a network connection device 19. Furthermore, the information processing apparatus 100 may be provided with an input device 13, an output device 14, and a medium driving device 17 as options. For example, there are cases in which the information processing apparatus 100 is realized as a computer or the like.

The processor 11 is an arbitrary processing circuit of the CPU 141. The processor 11 may be a Micro Processing Unit (MPU) that is installed in the control chip 110. The processor 11 can operate as the generation section 131, the specification section 132 and the control section 133. For example, the processor 11 can execute programs that are stored in the external storage device 16. The memory 12 operates as the memory 143. Alternatively, the memory 12 may operate as a storage section 120 inside the control chip 110. Furthermore, the memory 12 stores data that is obtained as a result of operation of the processor 11, data that is used in the processing of the processor 11 and the like, as appropriate. The network connection device 19 is used in communication with other devices. The network connection device 19 can operate as the communication ports 145a to 145c.

For example, the input device 13 can be realized as a button, a keyboard, a mouse or the like, and the output device 14 is realized as a display, or the like. The bus 15 is coupled between the processor 11, the memory 12, the input device 13, the output device 14, the external storage device 16, the medium driving device 17 and the network connection device 19 in a manner in which mutual transfer of data can be performed. The external storage device 16 stores programs, data, and the like. The external storage device 16 provides stored information to the processor 11, and the like, as appropriate. The medium driving device 17 can output data of the memory 12 or the external storage device 16 to a portable storage medium 18. The medium driving device 17 can read programs, data, and the like from the portable storage medium 18. In this instance, the portable storage medium 18 can be an arbitrary storage medium that can be carried around including a flexible disk, Magneto-Optical (MO) disk, a Compact Disc Recordable (CD-R) and a Digital Versatile Disk Recordable (DVD-R).

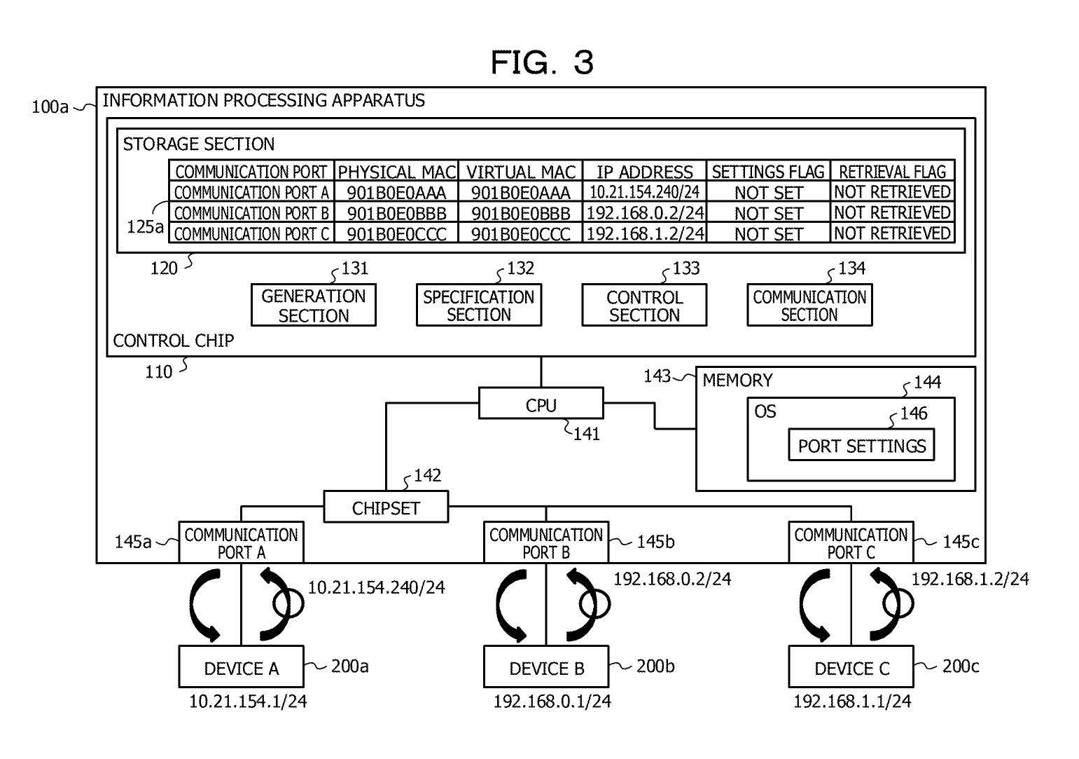

FIG. 3 is a view that describes an example of the information processing apparatus in a correct wiring state. In the information processing apparatus 100 of FIG. 3, the same numbers are given to components that are the same as those in the information processing apparatus 100 of FIG. 1. In an information processing apparatus 100a in FIG. 3, the device 200b and the communication port 145b are coupled, and the device 200c and the communication port 145c are coupled. Therefore, all of the communication ports 145 are in states in which it is possible to communicate with each wiring destination device 200 normally.

The devices 200a to 200c that are illustrated in FIG. 3 are coupled in a manner in which the devices 200a to 200c belong to the same communication segment as the respective communication ports 145. In a status in which correct wiring has been carried out in this manner, the CPU 141 acquires the IP address of each communication port 145 based on the port settings 146 that are stored in the memory 143, and executes a process that performs communication with the devices 200a to 200c, and the like.

In this instance, even in a status in which correct wiring has been carried out, the control chip 110 according to the present embodiment may control the CPU 141 in a manner in which the CPU 141 acquires the IP address of each communication port 145 from a port list 125a that is stored in the storage section 120. For example, the generation section 131 creates the port list 125a when the power of the information processing apparatus 100a is input. The port list 125a includes information of communication ports that are set as an initial configuration as a correct wiring state.

More specifically, the port list 125a is provided with communication ports, physical MAC addresses, virtual MAC addresses, IP addresses, settings flags, and retrieval flags. In a case in which the port list 125a is created as an initial configuration (a correct wiring state), the generation section 131 acquires information related to each communication port from the port settings 146. The generation section 131 creates the port list 125a by acquiring information that identifies each communication port (the communication ports 145a to 145c), and the physical MAC addresses and IP addresses that correspond to each communication port from the port settings 146.

The generation section 131 stores MAC addresses that are the same as the physical MAC addresses as the virtual MAC addresses. The generation section 131 stores information that indicates “Not Set” as the settings flags. The generation section 131 stores information that indicates “Not Retrieved” as the retrieval flags. The virtual MAC addresses, the settings flags and the retrieval flags will be described in more detail later since these elements are used in a process of the specification section 132.

In this manner, as a result of being provided with the port list 125a, which includes the physical MAC addresses and the IP addresses that correspond to each communication port 145, the control section 133 can control communication of the CPU 141 with the devices 200.

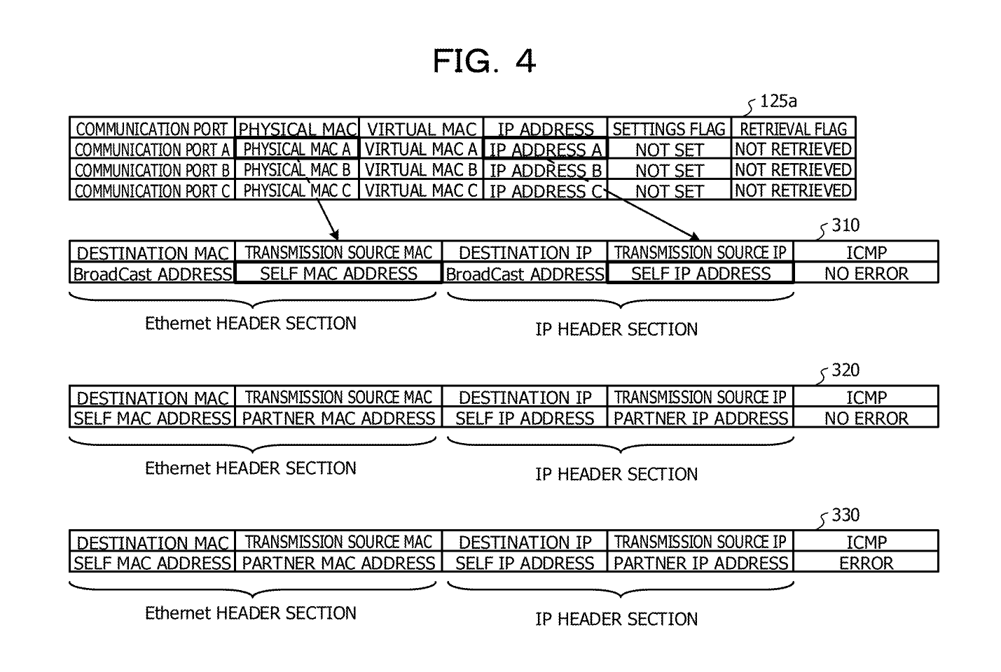

FIG. 4 is a view that describes an example of a process of connection confirmation in a communication section. FIG. 4 is an example of the processes that are indicated in (A1) in the communication section 134. When the power of the information processing apparatus 100a is input, the communication section 134 selects a single communication port that is maintained in the port list 125a. Further, the communication section 134 sends an order to perform connection confirmation of a communication segment network of an IP address that corresponds to the corresponding communication port, to the CPU 141.

For example, the connection confirmation is a Ping. A connection confirmation packet 310 is an example of a packet that the communication section 134 sends to the CPU 141. The connection confirmation packet 310 includes a destination MAC, a transmission source MAC, a destination IP, a transmission source IP, and an Internet Control Message Protocol (ICMP) message section. A MAC address that indicates a Broadcast address is stored as the destination MAC. The Broadcast address is stored as the destination MAC. Therefore, the connection confirmation packet 310 is delivered to all of the devices (destinations) that are included in the communication segment network, to which the communication port belongs. The MAC address (transmission source) of the communication port that was selected in (A1) is stored as the transmission source MAC based on the port list 125a. The destination MAC and the transmission source MAC belong to a header in an Ethernet (Registered Trademark) frame.

An IP address that indicates the Broadcast address is stored as the destination IP of the connection confirmation packet 310. The Broadcast address is stored as the destination IP. Therefore, the connection confirmation packet 310 is delivered to all of the devices (destinations) that are included in the communication segment network, to which the communication port belongs. The IP address (transmission source) of the communication port that was selected in (A1) is stored as the transmission source IP of the connection confirmation packet 310 based on the port list 125a. Since the transmission source IP and the transmission source MAC are stored in the connection confirmation packet 310, various devices that receive the connection confirmation packet 310 can return a response to the connection confirmation to the corresponding transmission source. The destination IP and the transmission source IP belong to an IP header in an Ethernet (Registered Trademark) frame. The ICMP message section stores a message of a response result to the connection confirmation packet 310. Since a response result is yet to be issued at a point in time of the connection confirmation packet 310, information that indicates that there is not an error, is stored in the ICMP message section.

A response packet 320 is a packet that includes information that indicates “Communication O.K.” from a device that belongs to the same communication segment as the communication packet with respect to the connection confirmation packet 310, and is sent to a sending source of the connection confirmation packet 310. The response packet 320 includes a destination MAC, a transmission source MAC, a destination IP, a transmission source IP, and an ICMP message section. The MAC address of the communication port that transmitted the connection confirmation packet 310 is stored as the destination MAC. The MAC address of the device 200 that returned the response is stored as the transmission source MAC. The IP address of the communication port that transmitted the connection confirmation packet 310 is stored as the destination IP. The IP address of the device 200 that returned the response is stored as the transmission source IP. Since it is a case in which the device 200 belongs to the same segment as the communication segment of the communication port, information that indicates “Communication O.K.” is stored in the ICMP message section. As a result of the communication section 134 acquiring such a response packet 320, the communication section 134 can determine whether or not a device that belongs to the same communication segment as the communication port is coupled to the corresponding communication port.

Meanwhile, a response packet 330 is a packet that includes information that indicates “Response Error” from a device 200 that belongs to a different communication segment with respect to the connection confirmation packet 310, and is sent to a sending source of the connection confirmation packet 310. The response packet 330 includes a destination MAC, a transmission source MAC, a destination IP, a transmission source IP, and an ICMP message section. The MAC address of the communication port that transmitted the connection confirmation packet 310 is stored as the destination MAC. The MAC address of the device 200 that returned the response is stored as the transmission source MAC. The IP address of the communication port that transmitted the connection confirmation packet 310 is stored as the destination IP. The IP address of the device 200 that returned the response is stored as the transmission source IP. Since it is a case in which the device 200 belongs to a different segment to the communication segment of the communication port, information that indicates “Response Error” is stored in the ICMP message section. As a result of the communication section 134 acquiring the response packet 330, the communication section 134 can determine that a device that differs from the communication segment of the communication port is coupled to the communication port.

In the processes of (A1), the communication section 134 sends the connection confirmation packet 310 to the communication segment networks to which each communication port belongs, based on the port list 125a. A device 200 that receives the connection confirmation packet 310 determines whether or not the communication port that corresponds to the transmission source and itself belong to the same communication segment. In a case in which the connection confirmation packet 310 is received from a communication port that belongs to the same communication segment as the device, the device 200 sends the response packet 320. In a case in which the connection confirmation packet 310 is received from a communication port that belongs to a different communication segment to the device, the device 200 sends the response packet 330. As a result of performing connection confirmation using such a method, the specification section 132 can specify communication ports that have wiring errors.

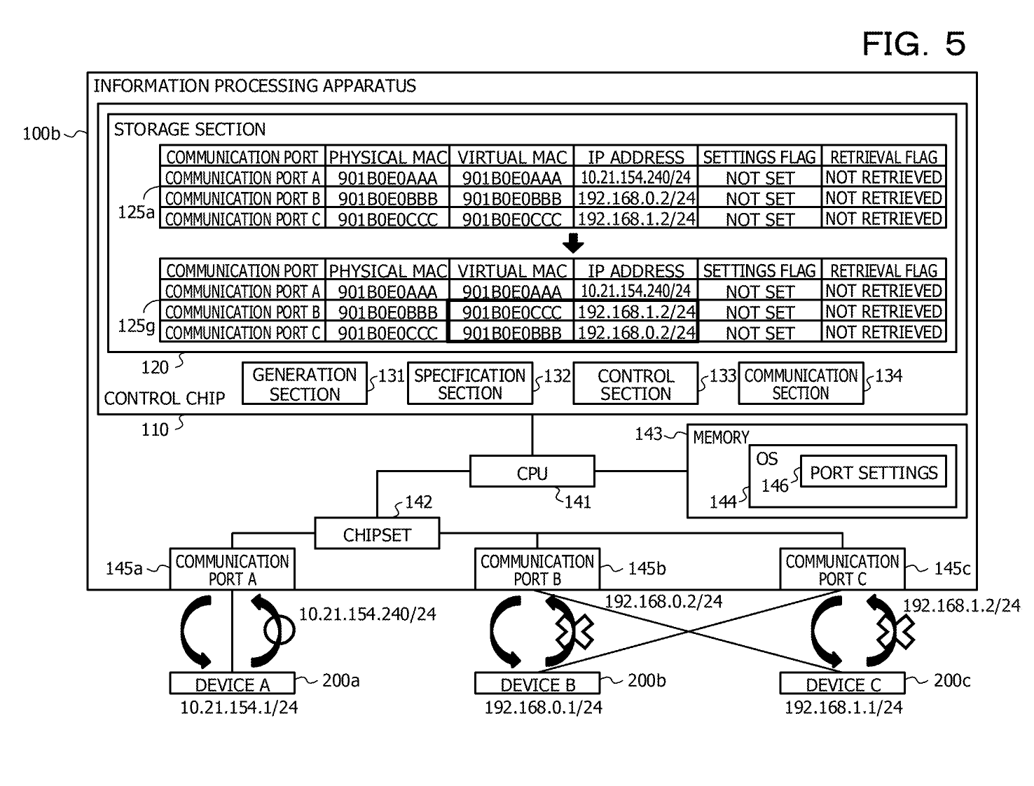

FIG. 5 is a view that describes an example of an incorrectly wired information processing apparatus. In an information processing apparatus 100b of FIG. 5, the same numbers are given to components that are the same as those in FIG. 3. In the information processing apparatus 100b in FIG. 5, an example of a case in which a worker has carried out incorrect wiring by incorrectly performing work on the information processing apparatus 100a in FIG. 3, which is wired correctly.

Since incorrect wiring has been performed, the control chip 110 automatically corrects the communication port settings to IP addresses that match the applications of the connected networks by executing the processes of (A1) to (A4). As a result of this, the generation section updates the port list 125a that was generated during the initial configuration, in the manner of the port list 125g.

In the port list 125g, the virtual MAC addresses and IP addresses that correspond to the communication port 145b and the communication port 145c, for which incorrect wiring was carried out, are exchanged from the state of the port list 125a. More specifically, “Physical MAC: 901B0E0BBB”, “Virtual MAC: 901B0E0BBB”, “IP Address 192.168.0.2/24” is stored in the port list 125a with respect to the communication port 145b. “Physical MAC: 901B0E0CCC”, “Virtual MAC: 901B0E0CCC”, “IP Address 192.168.1.2/24” is stored in the port list 125a with respect to the communication port 145c. Although exchange of the MAC addresses and IP addresses is performed in the port list, in a practical sense, the MAC address and the IP address of each device and communication port is not changed.

Meanwhile, “Physical MAC: 901B0E0BBB”, “Virtual MAC: 901B0E0CCC”, “IP Address 192.168.1.2/24” is stored in the port list 125g to correspond to the communication port 145b. Meanwhile, “Physical MAC: 901B0E0CCC”, “Virtual MAC: 901B0E0BBB”, “IP Address 192.168.0.2/24” is stored in the port list 125g to correspond to the communication port 145c.

In a case in which the updated port list 125g is stored in the storage section 120 of the control chip 110, the control section 133 controls the CPU 141 based on the port list 125g. For example, in a case in which the CPU 141 uses the communication port 145b, the control section 133 causes the CPU 141 to recognize that the MAC address of the communication port 145b is the “Virtual MAC: 901B0E0CCC” and the IP address thereof is the “IP Address: 192.168.1.2/24”. As a result of this, the CPU 141 can perform a communication process with the device 200c by assuming that the communication port 145b is a communication port that belongs to the communication segment “192.168.1.1 to 255” (the communication segment to which the communication port 145c belongs). In a case in which the CPU 141 uses the communication port 145c, the control section 133 causes the CPU 141 to recognize that the MAC address of the communication port 145c is the “Virtual MAC: 901B0E0BBB” and the IP address thereof is the “IP Address 192.168.0.2/24”. As a result of this, the CPU 141 can perform a communication process with the device 200b by assuming that the communication port 145c is a communication port that belongs to the communication segment “192.168.0.1 to 255” (the communication segment to which the communication port 145b belongs). In other words, the virtual MAC is used in order to allocate a MAC address that differs from the original physical MAC address, to a communication port.

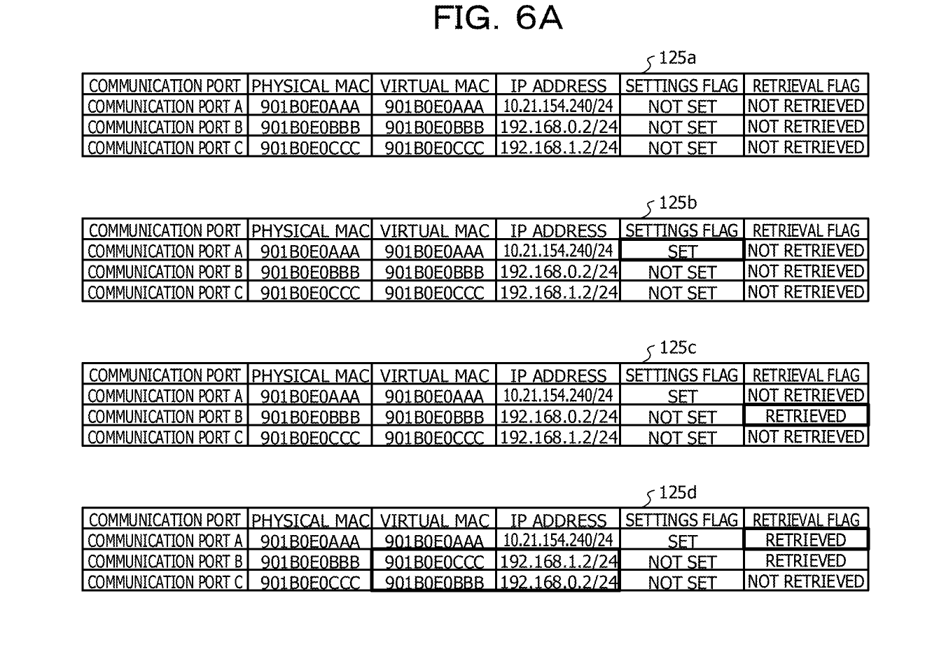

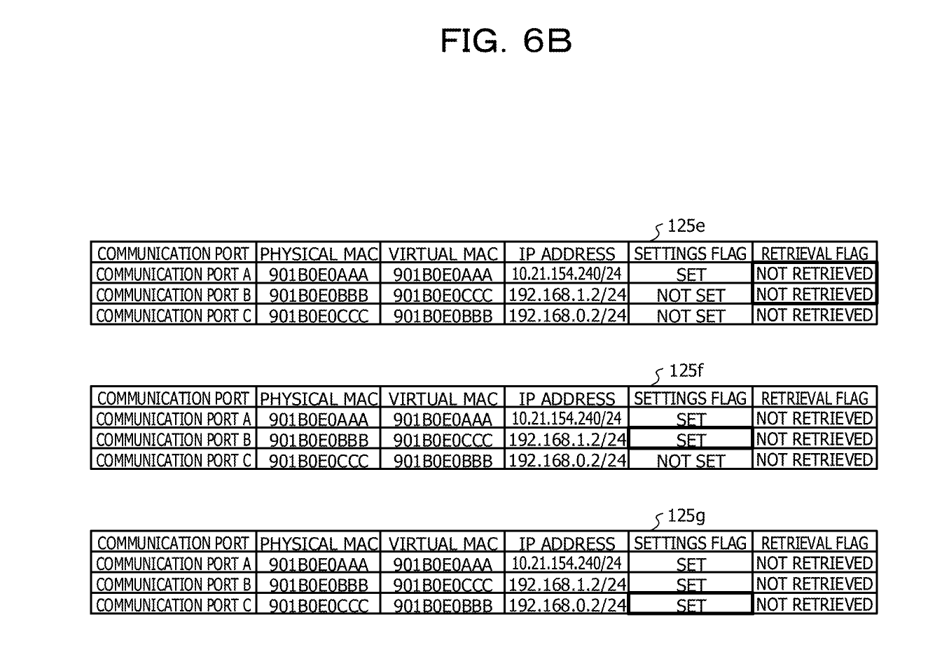

From then on, a process of updating until the port list 125g as a result of the port list 125a being updated will be described in order using FIGS. 6A and 6B. FIGS. 6A and 6B are views (1 of 2) that describe an example of a process that updates a port list. The port list 125a includes information of communication ports that are set as an initial configuration as a correct wiring state.

In this instance, a process of the control chip 110 after a worker temporarily removes, and then rewires all of the communication cables, will be described in order.

The communication section 134 selects a single communication port (for example, the communication port 145a) in order from the top of the port list 125a. The communication section 134 acquires the IP address “10.21.154.240/24” of the communication port 145a from the port list 125a. Thereafter, the communication section 134 sends an order to perform connection confirmation to the communication segment network “10.21.154.1 to 255” to which the communication port 145a belongs, to the CPU 141 using a broadcast. The device 200a, which belongs to the same communication segment as the communication port 145a returns a response to the connection confirmation to the information processing apparatus 100b. The control section 133 determines that there is not a problem in the connection of the communication port 145a and the device 200a.

When this occurs, the generation section 131 stores information that indicates “Set”, which indicates that setting of the MAC address and the IP address of the communication port 145a is complete, as the settings flag that corresponds to the communication port 145a of the port list. As a result of this, the generation section 131 updates the port list in the manner indicated in a port list 125b.

Next, the communication section 134 selects a single communication port (for example, the communication port 145b) in order from the top of the most recent port list 125b. When selecting a single communication port, the communication section 134 skips communication ports for which “Set” is set as the settings flag of the port list 125. The communication section 134 acquires the IP address “192.168.0.2/24” of the communication port 145b from the port list 125b. Thereafter, the communication section 134 sends an order to perform connection confirmation to the communication segment network “192.168.0.1 to 255” to which the communication port 145b belongs, to the CPU 141 using a broadcast. However, since the device 200c, which belongs to a different communication segment, is coupled to the communication port 145b, the response to the connection confirmation is returned as “Response Error”. The control section 133 determines that there is a problem in the device 200 that is coupled to the communication port 145b.

When this occurs, the generation section 131 stores information that indicates “Retrieved”, which indicates connection confirmation of the communication segment to which the corresponding communication port 145b belongs, is complete, as the retrieval flag that corresponds to the communication port 145b of the port list. As a result of this, the generation section 131 updates the port list in the manner indicated in a port list 125c.

The specification section 132 initiates a process that specifies a correct connection destination of the communication port 145b, for which there was a response error. The specification section 132 selects a single communication port (for example, the communication port 145a) in order from the top of the most recent port list 125c. When selecting a single communication port, the specification section 132 skips communication ports for which “Retrieved” is set as the retrieval flag of the port list 125. The communication section 134 sends an order to perform connection confirmation (for example, a Ping) of the communication segment network of the communication port 145a from the communication port 145b to the CPU 141. However, since the device 200c, is coupled to the communication port 145b, the response to the connection confirmation is returned as “Response Error”. The specification section 132 determines that the device 200 that is coupled to the communication port 145b does not belong to the communication segment of the communication port 145a. The generation section 131 stores information that indicates “Retrieved” as the retrieval flag that corresponds to the communication port 145a of the port list.

The specification section 132 selects a single communication port (for example, the communication port 145c) in order from the top of the most recent port list 125c. When selecting a single communication port, the specification section 132 skips communication ports (the communication ports 145a and 145b) for which “Retrieved” is set as the retrieval flag of the port list 125. The communication section 134 sends an order to perform connection confirmation (for example, a Ping) of the communication segment network of the communication port 145c from the communication port 145b to the CPU 141. When this occurs, a response to the connection request from the communication port 145b is fed back from the device 200c. The specification section 132 specifies that the device that belongs to the communication segment of the communication port 145c is wired to the communication port 145b.

The generation section 131 updates the port list in the manner indicated in a port list 125d by replacing the “Virtual MAC” and the “IP Address” that correspond to the communication port 145b with the “Virtual MAC” and the “IP Address” of the communication port 145c. More specifically, the generation section 131 stores “Virtual MAC: 901B0E0CCC”, “IP Address 192.168.1.2/24” (which belong to the communication port 145c) to correspond to the communication port 145b in the port list 125d. The generation section 131 stores “Virtual MAC: 901B0E0BBB”, “IP Address 192.168.0.2/24” (which belong to the communication port 145b) to correspond to the communication port 145c in the port list 125d.

The control chip 110 specifies the correct wiring destination of the communication port 145b and since the port list 125 is corrected, initiates post-processing. The generation section 131 stores “Not Retrieved” in all of the retrieval flags in the port list 125d. The generation section 131 updates the port list in the manner indicated in a port list 125e.

The generation section 131 stores information that indicates “Set”, which indicates that setting of the MAC address and the IP address of the communication port 145b is complete, as the settings flag that corresponds to the communication port 145b of the port list. As a result of this, the generation section 131 updates the port list in the manner indicated in a port list 125f.

The communication section 134 selects a single communication port (for example, the communication port 145c) in order from the top of the most recent port list 125f. When selecting a single communication port, the communication section 134 skips communication ports for which “Set” is set as the settings flag of the port list 125. The communication section 134 acquires the IP address “192.168.0.2/24” of the communication port 145c from the port list 125f. The communication section 134 sends an order to perform connection confirmation to the communication segment network “192.168.0.1 to 255” to which the communication port 145c is set to belong, to the CPU 141 using a broadcast. The device 200a, which belongs to “192.168.0.1 to 255”, returns a response to the connection confirmation to the information processing apparatus 100b. The control section 133 determines that there is not a problem in the connection of the communication port 145c and the device 200b.

The generation section 131 stores information that indicates “Set”, which indicates that setting of the MAC address and the IP address of the communication port 145c is complete, as the settings flag that corresponds to the communication port 145c of the port list. As a result of this, the generation section 131 updates the port list in the manner indicated in a port list 125g.

In this manner, when connection errors of the communication cables that are coupled to the information processing apparatus 100b, are detected, the control chip 110 creates a port list in which the correspondence relationships of the communication ports and the IP addresses are corrected. The control chip 110 can make normal communication possible in a status in which there is a wiring error by controlling communication with the devices based on the port list.

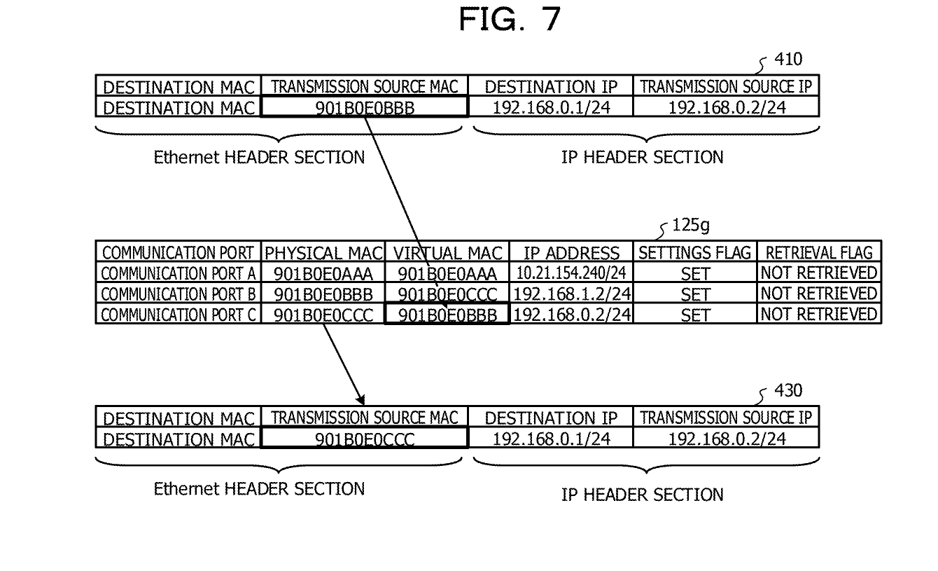

FIG. 7 is a view that describes an example of a transmission packet frame. The control section 133 controls communication processes of the CPU 141 with devices using the port list 125g that maintains information in which an incorrect wiring state is corrected.

For example, in a case of communication using the communication port 145b being desired, the CPU 141 creates a transmission packet 410 based on the port settings 146. The transmission packet 410 includes at least a destination MAC, a transmission source MAC, a destination IP, and a transmission source IP. The MAC address of a device that corresponds to a destination is stored as the destination MAC. The MAC address of the communication port 145b is stored as the transmission source MAC. The IP address of the device that corresponds to the destination is stored as the destination IP. The IP address of the communication port 145b is stored as the transmission source IP.

In this instance, the control section 133 converts the transmission packet 410 based on the most recent port list 125g. The control section 133 specifies a communication port that is provided with a virtual MAC that coincides with the transmission source MAC, which is included in the transmission packet 410, from the port list 125. The MAC address of the communication port 145b coincides with the virtual MAC address of the communication port 145c of the port list 125g. The control section 133 stores the MAC address of the communication port 145c as the transmission source MAC of the transmission packet 410.

Therefore, in a case of executing a communication process with the CPU 141 using the communication port 145b, the corresponding communication process is performed from the communication port 145c.

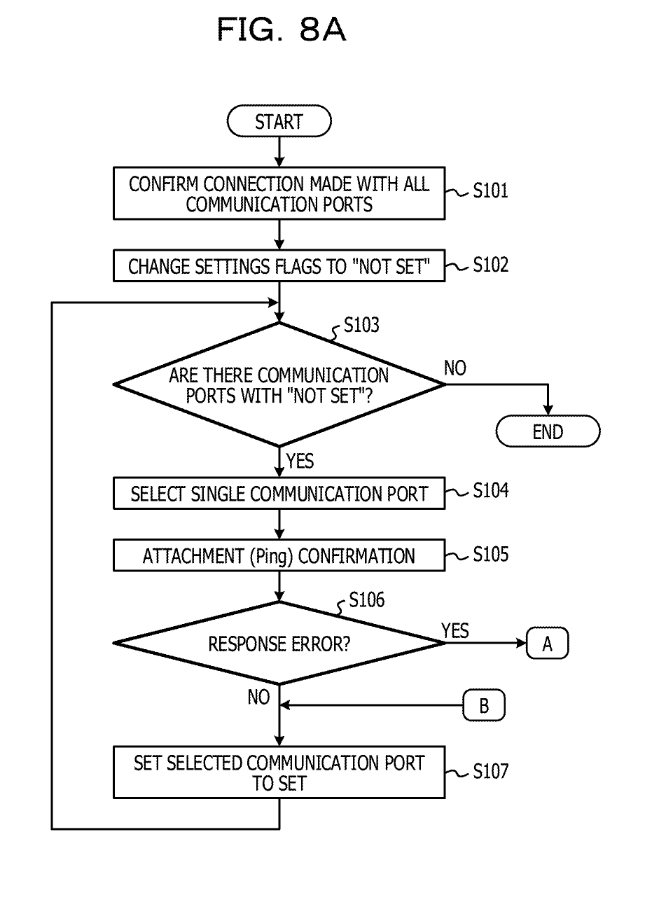

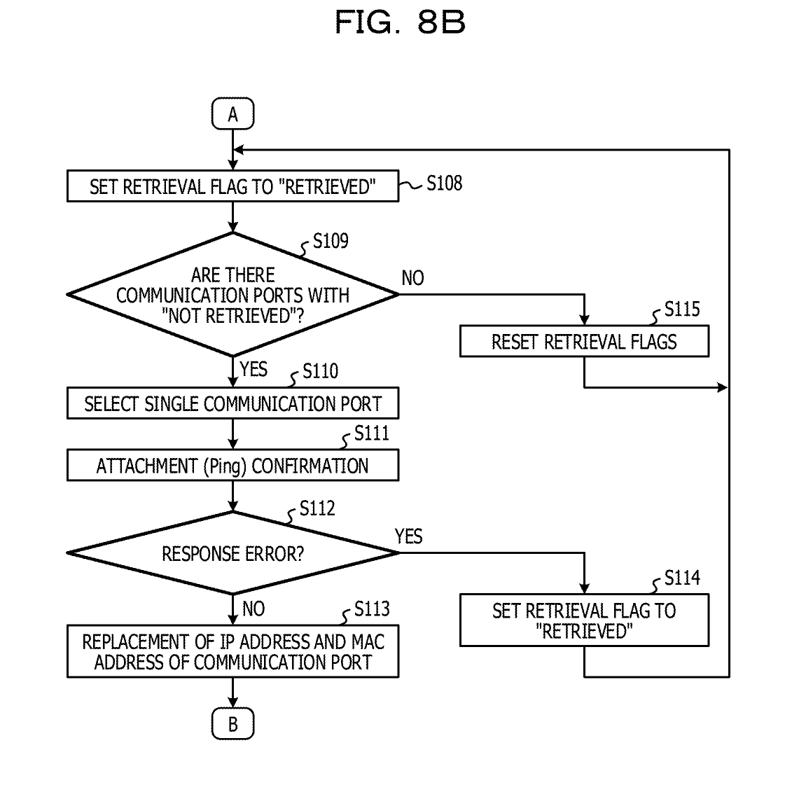

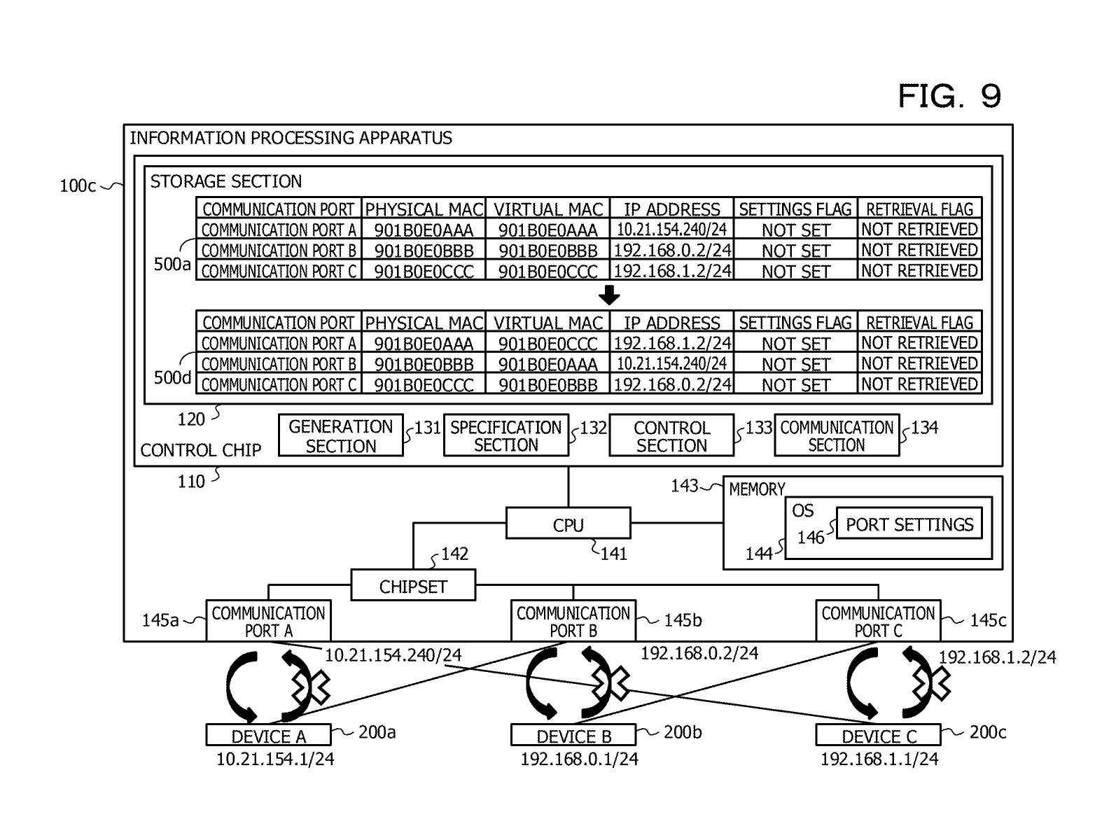

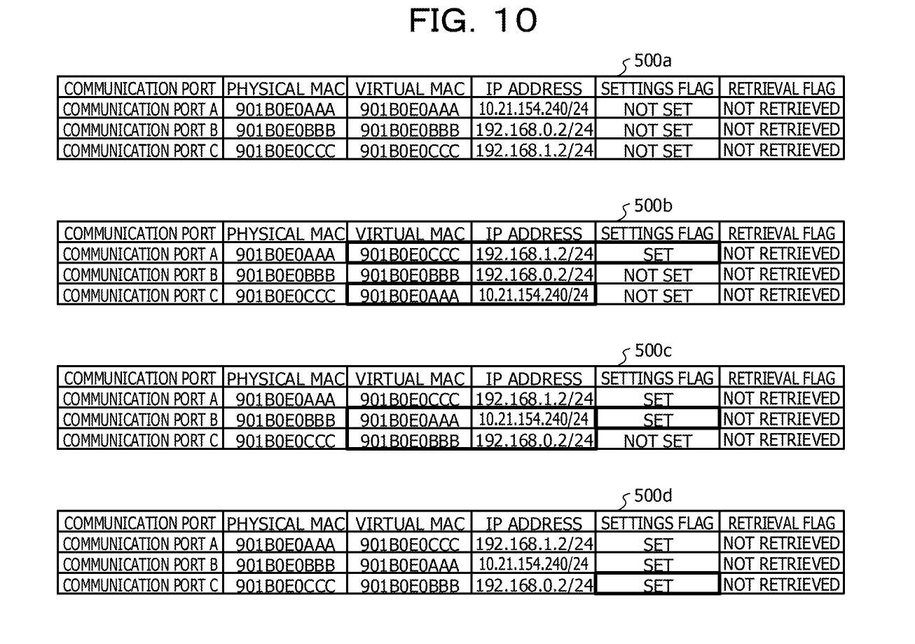

FIGS. 8A and 88 are flowcharts that describe an example of a process in the information processing apparatus according to the present embodiment. The control section 133 confirms that a communication cable is wired to all of the communication ports (S101). The generation section 131 changes all of the settings flags of the port list to “Not Set” (S102). The communication section 134 determines whether or not there is a communication port with “Not Set” as the settings flag of the port list (S103). In a case in which there is a communication port for which “Not Set” is set as the settings flag of the port list (YES in S103), the communication section 134 selects a single communication port for which not set is set (S104). The communication section 134 sends an order to perform connection confirmation to the communication segment network to which the selected communication port belongs, to the CPU 141 using a broadcast (S105). The control section 133 determines whether or not a response error was received as the response to the connection confirmation (S106). In a case in which there was not a response error as the result of the connection confirmation (NO in S106), the generation section 131 stores information that indicates “Set” as the settings flag, which corresponds to the selected communication port 145 in the port list (S107). When the process of S107 is finished, the control chip 110 repeats the processes from S103.

The communication section 134 determines whether or not there is a communication port with “Not Retrieved” as the retrieval flag of the port list (S109). In a case in which there is a communication port for which “Not Retrieved” is set as the retrieval flag of the port list (YES in S109), the communication section 134 selects a single communication port for which not retrieved is set (S110). The communication section 134 sends an order to perform connection confirmation to the communication segment network to which the selected communication port belongs, to the CPU 141 using a broadcast (S111). The control section 133 determines whether or not a response error was received as the response to the connection confirmation (S112). In a case in which there is not a response error (NO in S112), the generation section 131 updates the port list (S113). The generation section 131 updates the port list by replacing the MAC address and the IP address of the communication port, for which there was a response error in S106, with the MAC address and the IP address of the communication port for which there was not a response error in S112. When the process of S113 is finished, the control chip 110 repeats the processes from S107.

In a case in which there is a response error (YES in S112), the generation section 131 updates by setting “Retrieved” as the retrieval flag that corresponds to the communication port that was selected in S110 in the port list (S114). When the process of S114 is finished, the control chip 110 repeats the processes from S108. In a case in which there is not a communication port for which “Not Retrieved” is set as the retrieval flag of the port list (NO in S109), the generation section 131 updates the port list so that Not Retrieved is set as the retrieval flag of all of the communication ports (S115). When the process of S115 is finished, the control chip 110 repeats the processes from S108.

In a case in which there is not a communication port for which “Not Set” is set as the settings flag of the port list (NO in S103), control chip 110 finishes the process of updating the port list.

In this manner, when connection errors of the communication cables that are coupled to the information processing apparatus 100b, are detected, the control chip 110 creates a port list in which the correspondence relationships of the communication ports and the IP addresses are corrected. The control chip 110 can make normal communication possible in a status in which there is a wiring error by controlling communication with the devices based on the port list.

The information processing apparatus according to the embodiment of FIGS. 1 to 8B is an example of a case in which there is a wiring error at two communication ports. Even if there are wiring errors across a plurality of communication ports, the information processing apparatus according to the present embodiment can automatically transition to a status in which communication is possible by correcting the correspondence relationships of the communication ports, IP and MAC addresses.

FIG. 9 is a view that describes an example of an information processing apparatus in which there are wiring errors across a plurality of communication ports. In an information processing apparatus 100c of FIG. 9, the same numbers are given to components that are the same as those in the information processing apparatus 100 of FIG. 1. In the information processing apparatus 100c in FIG. 9, the device 200a and the communication port 145b are coupled, the device 200b and the communication port 145c are coupled, and the device 200c and the communication port 145a are coupled. This is a state in which there is not a wiring at which the communication segment that the device 200 belongs to and the communication segment that the communication port 145 belongs to, are the same, and in which communication to the devices is not possible from any of the communication ports.

The control chip 110 automatically corrects the communication port settings to IP addresses that match the applications of the connected networks by executing the processes of (A1) to (A4). A port list 500a is stored in the storage section 120 in an initial configuration (a case in which correct wiring is carried out). The control chip 110 updates the port list 500a in the manner of a port list 500d by automatically correcting the communication port settings to IP addresses that match the applications of the connected networks.

Meanwhile, “Physical MAC: 901B0E0AAA”, “Virtual MAC: 901B0E0CCC”, “IP Address 192.168.1.2/24” is stored in the port list 500d to correspond to the communication port 145a. “Physical MAC: 901B0E0BBB”, “Virtual MAC: 901B0E0AAA”, “IP Address 10.21.154.240/24” is stored in the port list 500d to correspond to the communication port 145b. “Physical MAC: 901B0E0CCC”, “Virtual MAC: 901B0E0BBB”, “IP Address 192.168.0.2/24” is stored in the port list 500d to correspond to the communication port 145c.

In a case in which the updated port list 500d is stored in the storage section 120 of the control chip 110, the control section 133 controls the CPU 141 based on the port list 500d. For example, in a case in which the CPU 141 uses the communication port 145a, the control section 133 causes the CPU 141 to recognize that the MAC address of the communication port 145a is the “Virtual MAC: 901B0E0CCC” and the IP address thereof is the “IP Address: 192.168.1.2/24”. As a result of this, the CPU 141 can perform a communication process with the device 200c by assuming that the communication port 145a is a communication port that belongs to the communication segment “192.168.1.1 to 255” (the communication segment to which the communication port 145c belongs). In a case in which the CPU 141 uses the communication port 145b, the control section 133 causes the CPU 141 to recognize that the MAC address of the communication port 145b is the “Virtual MAC: 901B0E0AAA” and the IP address thereof is the “IP Address: 10.21.154.240/24”. As a result of this, the CPU 141 can perform a communication process with the device 200a by assuming that the communication port 145b is a communication port that belongs to the communication segment “10.21.154.1 to 255” (the communication segment to which the communication port 145a belongs). In a case in which the CPU 141 uses the communication port 145c, the control section 133 causes the CPU 141 to recognize that the MAC address of the communication port 145c is the “Virtual MAC: 901B0E0BBB” and the IP address thereof is the “IP Address: 192.168.0.2/24”. As a result of this, the CPU 141 can perform a communication process with the device 200b by assuming that the communication port 145c is a communication port that belongs to the communication segment “192.168.0.1 to 255” (the communication segment to which the communication port 145b belongs).

From then on, a process of updating until the port list 500d as a result of the port list 500a being updated will be described in order using FIG. 10. FIG. 10 is a view (2 of 2) that describes an example of a process that updates a port list. The port list 500a includes information of communication ports that are set as an initial configuration as a correct wiring state.

In this instance, a process of the control chip 110 after a worker temporarily removes, and then rewires all of the communication cables, will be described in order.

The communication section 134 selects a single communication port (for example, the communication port 145a) in order from the top of the port list 500a. The communication section 134 acquires the IP address “10.21.154.240/24” of the communication port 145a from the port list 500a. Thereafter, the communication section 134 sends an order to perform connection confirmation to the communication segment network “10.21.154.1 to 255” to which the communication port 145a belongs, to the CPU 141 using a broadcast. However, since the device 200c, which belongs to a different communication segment, is coupled to the communication port 145a, the response to the connection confirmation is returned as “Response Error”. The control section 133 determines that there is a problem in the device 200 that is coupled to the communication port 145a.

Further, the generation section 131 stores information that indicates “Retrieved”, which indicates connection confirmation of the communication segment to which the corresponding communication port 145a belongs, is complete, as the retrieval flag that corresponds to the communication port 145a of the port list.

The specification section 132 initiates a process that specifies a correct connection destination of the communication port 145a, for which there was a response error. The specification section 132 selects a single communication port (for example, the communication port 145b) in order from the top of the most recent port list 500a. When selecting a single communication port, the specification section 132 skips communication ports for which “Retrieved” is set as the retrieval flag of the port list 500. The communication section 134 sends an order to perform connection confirmation (for example, a Ping) of the communication segment network of the communication port 145b from the communication port 145a to the CPU 141. However, since the device 200c, is coupled to the communication port 145a, the response to the connection confirmation is returned as “Response Error”. The specification section 132 determines that the device 200 that is coupled to the communication port 145a does not belong to the communication segment of the communication port 145b. The generation section 131 stores information that indicates “Retrieved” as the retrieval flag that corresponds to the communication port 145b of the port list.

The specification section 132 selects a single communication port (for example, the communication port 145c) in order from the top of the most recent port list 500c. When selecting a single communication port, the specification section 132 skips communication ports (the communication ports 145a and 145b) for which “Retrieved” is set as the retrieval flag of the port list 500. The communication section 134 sends an order to perform connection confirmation (for example, a Ping) of the communication segment network of the communication port 145c from the communication port 145a to the CPU 141. When this occurs, a response to the connection request from the communication port 145a is fed back from the device 200c. The specification section 132 specifies that the device that belongs to the communication segment of the communication port 145c is wired to the communication port 145a.

The generation section 131 updates the port list in the manner indicated in a port list 500b by replacing the “Virtual MAC” and the “IP Address” that correspond to the communication port 145a with the “Virtual MAC” and the “IP Address” of the communication port 145c. More specifically, the generation section 131 stores “Virtual MAC: 901B0E0CCC”, “IP Address 192.168.1.2/24” (which belong to the communication port 145c) to correspond to the communication port 145a. More specifically, the generation section 131 stores “Virtual MAC: 901B0E0AAA”, “IP Address 10.21.154.240/24” (which belong to the communication port 145a) to correspond to the communication port 145c.

The control chip 110 specifies the correct wiring destination of the communication port 145a and since the port list 500 is corrected, initiates post-processing. The generation section 131 stores “Not Retrieved” in all of the retrieval flags in the port list 500. The generation section 131 updates the port list in the manner indicated in a port list 500b.

The generation section 131 stores information that indicates “Set”, which indicates that setting of the MAC address and the IP address of the communication port 145a is complete, as the settings flag that corresponds to the communication port 145a of the port list. As a result of this, the generation section 131 updates the port list in the manner indicated in a port list 500b.

The communication section 134 selects a single communication port (for example, the communication port 145b) in order from the top of the most recent port list 500b. The communication section 134 acquires the IP address “192.168.0.2/24” of the communication port 145b from the port list 500b. Thereafter, the communication section 134 sends an order to perform connection confirmation to the communication segment network “192.168.0.1 to 255” to which the communication port 145b belongs, to the CPU 141 using a broadcast. However, since the device 200a, which belongs to a different communication segment, is coupled to the communication port 145b, the response to the connection confirmation is returned as “Response Error”. The control section 133 determines that there is a problem in the device 200 that is coupled to the communication port 145b.

When this occurs, the generation section 131 stores information that indicates “Retrieved”, which indicates connection confirmation of the communication segment to which the corresponding communication port 145b belongs, is complete, as the retrieval flag that corresponds to the communication port 145b of the port list.

The specification section 132 initiates a process that specifies a correct connection destination of the communication port 145b, for which there was a response error. The specification section 132 selects a single communication port (for example, the communication port 145a) in order from the top of the most recent port list 500b. When selecting a single communication port, the specification section 132 skips communication ports for which “Retrieved” is set as the retrieval flag of the port list 500. The communication section 134 sends an order to perform connection confirmation (for example, a Ping) of the communication segment network of the communication port 145a from the communication port 145b to the CPU 141. In this instance, the communication segment of the communication port 145a is “192.168.1.1 to 255” that belongs to the communication port 145c in the initial configuration. However, since the device 200a, which belongs to a different communication segment to the “192.168.1.1 to 255”, is coupled to the communication port 145b, the response to the connection confirmation is returned as “Response Error”. The specification section 132 determines that the device 200 that is coupled to the communication port 145b does not belong to the communication segment of the communication port 145a. The generation section 131 stores information that indicates “Retrieved” as the retrieval flag that corresponds to the communication port 145a of the port list.

The specification section 132 selects a single communication port (for example, the communication port 145c) in order from the top of the most recent port list 500b. When selecting a single communication port, the specification section 132 skips communication ports (the communication ports 145a and 145b) for which “Retrieved” is set as the retrieval flag of the port list 500. The communication section 134 sends an order to perform connection confirmation (for example, a Ping) of the communication segment network of the communication port 145c from the communication port 145b to the CPU 141. In this instance, the communication segment of the communication port 145c is “10.21.154.1 to 255” that belongs to the communication port 145a in the initial configuration. Since the device 200a, which belongs to the communication segment of “10.21.154.1 to 255”, is coupled to the communication port 145b, the response to the connection confirmation is fed back from the device 200a. The specification section 132 specifies that the device that belongs to the communication segment of the communication port 145a (the communication port 145c in the port list 500b) is wired to the communication port 145b.

The generation section 131 updates the port list in the manner indicated in a port list 500c by replacing the “Virtual MAC” and the “IP Address” that correspond to the communication port 145b with the “Virtual MAC” and the “IP Address” of the communication port 145c. More specifically, the generation section 131 stores “Virtual MAC: 901B0E0AAA”, “IP Address 10.21.154.240/24” (which belong to the communication port 145a) to correspond to the communication port 145b. More specifically, the generation section 131 stores “Virtual MAC: 901B0E0BBB”, “IP Address 192.168.0.2/24” (which belong to the communication port 145b) to correspond to the communication port 145c.

The control chip 110 specifies the correct wiring destination of the communication port 145b and since the port list 500 is corrected, initiates post-processing. The generation section 131 stores “Not Retrieved” in all of the retrieval flags in the port list 500. The generation section 131 updates the port list in the manner indicated in a port list 500c.

The generation section 131 stores information that indicates “Set”, which indicates that setting of the MAC address and the IP address of the communication port 145b is complete, as the settings flag that corresponds to the communication port 145b of the port list. As a result of this, the generation section 131 updates the port list in the manner indicated in a port list 500c.

The communication section 134 selects a single communication port (for example, the communication port 145c) in order from the top of the most recent port list 500c. When selecting a single communication port, the communication section 134 skips communication ports for which “Set” is set as the settings flag of the port list 500. The communication section 134 acquires the IP address “192.168.1.2/24” of the communication port 145c from the port list 500c. Thereafter, the communication section 134 sends an order to perform connection confirmation to the communication segment network “192.168.1.1 to 255” to which the communication port 145c belongs, to the CPU 141 using a broadcast. The device 200b, which belongs to the same communication segment “192.168.1.1 to 255” as the communication port 145c returns a response to the connection confirmation to the information processing apparatus 100c. The control section 133 determines that there is not a problem in the connection of the communication port 145a and the device 200b.

The generation section 131 stores information that indicates “Set”, which indicates that setting of the MAC address and the IP address of the communication port 145c is complete, as the settings flag that corresponds to the communication port 145c of the port list. As a result of this, the generation section 131 updates the port list in the manner indicated in the port list 500d.

In this manner, when connection errors of the communication cables that are coupled to the information processing apparatus 100b, are detected, the control chip 110 creates a port list in which the correspondence relationships of the communication ports and the IP addresses are corrected. The control chip 110 can make normal communication possible in a status in which there is a wiring error by controlling communication with the devices based on the port list.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A control method executed by a processor included in an information processing apparatus that includes a plurality of communication ports, the control method comprising:
storing a port list including information of the plurality of communication ports and addresses respectively allocated to one of the plurality of communication ports;
detecting that an address, which belongs to a communication segment of a first communication port among the plurality of communication ports, is not set to a device coupled to the first communication port, the communication segment indicating a group of addresses that are capable of mutual communication;
specifying a second communication port to which an address that belongs to a second communication segment of the device is set;
updating the port list by exchanging an address allocated to the specified second communication port, and an address allocated to the first communication port; and
executing communication with the device based on the updated port list.

2. The control method according to claim 1,
wherein the detecting includes
transmitting a message for connection confirmation from the first communication port, and
detecting that an address that belongs to the communication segment of the first communication port is not set to the device when a response to the message is received and the response indicates an error.

3. The control method according to claim 2,
wherein the message is a packet that includes a physical address of the first communication port.

4. The control method according to claim 3,
wherein the transmitting includes transmitting the packet to a plurality of devices that are included in the communication segment of the first communication port, and
the receiving includes receiving the responses transmitted by the plurality of devices, the responses including the physical addresses that are included in the packets as a destination.

5. The control method according to claim 1,
wherein the port list includes physical addresses respectively correspond to one of the plurality of communication ports, and virtual addresses indicating the same information as the physical addresses, and
the updating includes exchanging a virtual address that corresponds to the specified second communication port, and a virtual address that corresponds to the first communication port in a state in which the information of the physical address in the port list is retained.

6. The control method according to claim 1,
wherein the specifying includes:
acquiring respective communication segments of a plurality of other communication ports that differ from a communication port that receives a response among the plurality of communication ports, the response indicating an error,
transmitting a message for connection confirmation to a network of the respective communication segments of the plurality of other communication ports from the communication port that receives a response, which indicates an error, and
specifying the device based on a received response to the message.

7. An information processing apparatus comprising:
a plurality of communication ports;
a memory configured to store a port list that includes information of the plurality of communication ports and addresses respectively allocated to one of the plurality of communication ports; and
a processor coupled to the memory and configured to:
detect that an address, which belongs to a communication segment of a first communication port among the plurality of communication ports, is not set to a device coupled to the first communication port, the communication segment indicating a group of addresses that are capable of mutual communication,
specify a second communication port to which an address that belongs to a second communication segment of the device, is set,
update the port list by exchanging an address allocated to the specified second communication port, and an address allocated to the first communication port, and
execute communication with the device based on the updated port list.

8. The information processing apparatus according to claim 7,
wherein the processor is configured to:
transmit a message for connection confirmation from the first communication port, and
detect that an address that belongs to the communication segment of the first communication port is not set to the device when a response to the message is received and the response indicates an error.

9. The information processing apparatus according to claim 8,
wherein the message is a packet that includes a physical address of the first communication port.

10. The information processing apparatus according to claim 9,
wherein the processor is configured to:
transmit the packet to a plurality of devices that are included in the communication segment of the first communication port, and
receive the responses transmitted by the plurality of devices, the responses including the physical addresses that are included in the packets as a destination.

11. A non-transitory computer-readable storage medium storing a program that causes a processor included in an information processing apparatus to execute a process, the information processing apparatus storing a port list that includes information of a plurality of communication ports and addresses respectively allocated to one of the plurality of communication ports, the process comprising:
detecting that an address, which belongs to a communication segment of a first communication port among the plurality of communication ports, is not set to a device coupled to the first communication port, the communication segment indicating a group of addresses that are capable of mutual communication;
specifying a second communication port to which an address that belongs to a second communication segment of the device is set;
updating the port list by exchanging an address allocated to the specified second communication port, and an address allocated to the first communication port; and
executing communication with the device based on the updated port list.
